(19) United States
(12) Patent Application Publication
(10) Pub. No.: US 2004/0017428 A1
(43) Pub. Date: Jan. 29, 2004

(54) Method of using a sacrificial layer to create smooth exit holes using a laser drilling system

(76) Inventors: John Cronin, Milton, VT (US); Nancy Edwards, Essex Junction, VT (US)

Correspondence Address: HARNESS, DICKEY & PIERCE, P.L.C., P.O. BOX 828, BLOOMFIELD HILLS, MI, 48303, US

(21) Appl. No.: 10/266,933

(22) Filed: Oct. 8, 2002

Related U.S. Application Data
(60) Provisional application No. 60/398,640, filed on Jul. 25, 2002.

(51) Int. Cl. B23P 17/00; B41J 2/14

(52) U.S. Cl. 347/47; 29/890.1; 219/121.7

(57) ABSTRACT

A method of substantially eliminating imperfections in a laser milled workpiece, wherein the imperfections result from a laser drilling process, includes attaching a pre-milled sacrificial layer to a beam exit surface of a pre-milled workpiece, wherein the pre-milled sacrificial layer has a first laser ablation rate substantially matching a second laser ablation rate of the pre-milled workpiece. A passage is formed through the pre-milled workpiece and the pre-milled sacrificial layer by ablating workpiece and sacrificial layer material with a laser, thereby producing a laser-milled workpiece and laser-milled sacrificial layer with the imperfections substantially concentrated in the laser-milled sacrificial layer. The laser-milled sacrificial layer is removed from the workpiece, thereby substantially eliminating imperfections in the laser-milled workpiece.

### CROSS-REFERENCE TO RELATED APPLICATIONS

This application claims the benefit of U.S. Provisional Application No. 60/398,640, filed on Jul. 25, 2002. The disclosure of the above application is incorporated herein by reference.

### FIELD OF THE INVENTION

The present invention generally relates to laser drilling systems and methods, and particularly relates to use of a sacrificial layer in a laser drilling process.

### BACKGROUND OF THE INVENTION

Material ablation by pulsed light sources has been studied since the invention of the laser. Etching of polymers by ultraviolet (UV) excimer laser radiation in the early 1980s led to further investigations and developments in micromachining approaches using lasers—spurred by the remarkably small features that can be drilled, milled, and replicated through the use of lasers. A recent article entitled “Precise drilling with short pulsed lasers” (X. Chen and F. Tomoo, High Power Lasers in Manufacturing, Proceedings of the SPIE Vol. 3888, 2000) outlines a number of key considerations in micromachining. Other recent patents of interest include the following:

U.S. Pat. No. 6,323,456, “Method of forming an ink jet printhead structure,” describes a method for making an inkjet printhead nozzle plate from a composite strip containing a nozzle layer and an adhesive layer. The adhesive layer is coated with a polymeric sacrificial layer prior to laser ablating the flow features in the composite strip. A method is also provided for improving adhesion between the adhesive layer and the sacrificial layer. Once the composite strip containing the sacrificial layer is prepared, the coated composite strip is then laser ablated to form flow features in the strip in order to form the nozzle plates. After forming the flow features, the sacrificial layer is removed and the individual inkjet printhead nozzle plates are separated from the composite strip by singulating the nozzle plates with a laser.

U.S. Pat. No. 6,228,246, “Removal of metal skin from a copper-Invar-copper laminate,” describes a method of removing a metal skin from a through-hole surface of a copper-Invar-copper (CIC) laminate without causing differential etch back of the laminate. The metal skin includes debris deposited on the through-hole surface as laser or mechanical drilling of a substrate that includes the laminate as an inner plane is forming the through hole. Removing the metal skin combines electrochemical polishing (ECP) with ultrasonic. ECP dissolves the metal skin in an acid solution, while ultrasonic agitates and circulates the acid solution to sweep the metal skin out of the through-hole. ECP is activated when a pulse power supply is turned on and generates a periodic voltage pulse from a pulse power supply whose positive terminal is coupled to the laminate and whose negative terminal is coupled to a conductive cathode. After the metal skin is removed, the laminate is differentially etched such that the copper is etched at a faster rate than the Invar. To prevent the differential etching, a copper layer is formed on a surface of the substrate with an electrical resistance R₁ between the copper layer and the positive terminal of the pulse power supply. Additionally, an electrical resistance R₂ is formed between the laminate and the positive terminal of the pulse power supply. Adjustment of R₁ and R₂ controls the relative etch rates of the copper and the Invar.

U.S. Pat. No. 6,120,131, “Method of forming an inkjet printhead nozzle structure,” describes a composite structure containing a nozzle layer and an adhesive layer where the adhesive layer is coated with a polymeric sacrificial layer. The coated composite structure is laser ablated to form one or more nozzles in the structure and the sacrificial layer is then removed. The sacrificial layer is preferably a water-soluble polymer, such as polyvinyl alcohol or polyethylene oxide, which is removed by directing jets of water at the sacrificial layer until it is substantially removed from the adhesive layer.

U.S. Pat. No. 5,609,746, “Printed circuit manufacture,” describes a manufacturing method of a printed circuit board where a sacrificial tin-lead layer is deposited on the surface of the board by electroplating. Holes are then formed in the board by UV laser ablation. Debris from the ablation process is adsorbed on the sacrificial layer. The sacrificial layer is then removed by means of a chemical stripping process, along with the debris.

U.S. Pat. No. 4,948,941, “Method of laser drilling a substrate,” describes a method of laser drilling a substrate and includes the steps of: placing a sacrificial member over the substrate, and then laser drilling through the sacrificial member. This method produces a substantially uniform hole in the substrate.

Ultrafast lasers generate intense laser pulses with durations from roughly 10⁻¹¹ seconds (10 picoseconds) to 10⁻¹⁴ seconds (10 femtoseconds). Short pulse lasers generate intense laser pulses with durations from roughly 10⁻¹⁰ seconds (100 picoseconds) to 10⁻¹¹ seconds (10 picoseconds). Along with a wide variety of potential applications for ultrafast and short pulse lasers in medicine, chemistry, and communications, short pulse lasers are also useful in milling or drilling holes in a wide range of materials. In this regard, these lasers readily drill hole sizes in the sub-micron range. High aspect ratio holes are also drilled in hard materials; applications in this regard include cooling channels in turbine blades, nozzles in ink-jet printers, and via holes in printed circuit boards.

Creation of a repeatable hole shape that meets stringent specifications is frequently critical in quality control for manufacturing applications. Laser systems are flexible in meeting such specifications in milling because appropriate programming can easily engineer custom-designed two-dimensional (2D) and three-dimensional (3D) structures and translate such designs into numerical control of the laser in real-time. However, as the required feature size for these structures decreases, mass production of quality micromachined products becomes more difficult to conduct in a rapid, cost-effective manner that consistently meets product specifications.

Even as micro-technologies continue to provide products with ongoing decreases in size, the need for high product quality, adherence to stringent specifications, and manufacturing consistency continues. An example of a product having such stringent specifications is appreciated in consideration of the print quality and performance of an inkjet printer; this performance is closely related to tight control of the hole geometries of the inkjet workpieces (inkjet nozzles provided in inkjet nozzle plates).

Inkjet nozzle design, construction, and operation are all important factors in providing high quality inkjet print resolution. Inkjet nozzle designs, which typically include specific patterns of many ink jet holes, which in turn are also specific defined geometries, provide the templates for nozzle holes drilled in a thin foil or polymer to a particular shape. Each nozzle hole includes an input section, a shaped section and an exit hole section, and each exit hole section is preferably cut with a high degree of precision respective to the design pattern. In a particular nozzle, inconsistency in nozzle hole shape leads to inconsistent expulsion of inks among the individual holes in an inkjet nozzle, which negatively affects print resolution. Therefore, imperfections in the shape of the inkjet nozzle holes respective to the design pattern negatively impact print quality.

Although laser drilling of inkjet nozzles provides numerous advantages and benefits over other drilling methods, defects in the final product remain a problem. Current laser drilling systems, such as those using picosecond lasers, still induce burr and notch defects in the finished product. These defects are particularly detrimental in the exit hole because the size and smoothness specifications of the exit hole are critical to acceptable inkjet nozzle performance. Burrs or notches cause restrictions in the high velocity expulsion of inks and cause variability in the position and amount of ink per dot, causing poor print quality. Most current laser drilling techniques utilizing short pulse, low energy lasers use traditional trepanning (e.g. cutting a circular pattern to remove a core, leaving a hole) to create the exit hole. This trepanning method causes an unpredictable notch or burr to be formed in the otherwise cylindrical exit hole. This notch or burr is undesirable because of the negative impact it has on print quality. Insofar as the industry has a preference to use stainless steel as the best nozzle plate (workpiece) material in inkjet nozzles, there are also certain machining challenges in eliminating burrs and notches respective to the hardness properties of stainless steel alloys.

What is needed is a way to minimize defects in stainless steel laser drilling inkjet nozzles and thereby to enhance quality and consistency in manufactured inkjet nozzles. The present invention provides a solution to this need.

### SUMMARY OF THE INVENTION

According to the present invention, a method of substantially eliminating imperfections in a laser milled workpiece, wherein the imperfections result from a laser drilling process, includes attaching a pre-milled sacrificial layer to a beam exit surface of a pre-milled workpiece, wherein the pre-milled sacrificial layer has a first laser ablation rate substantially matching a second laser ablation rate of the pre-milled workpiece. A passage is formed through the pre-milled workpiece and the pre-milled sacrificial layer by ablating workpiece and sacrificial layer material with a laser, thereby producing a laser-milled workpiece and laser-milled sacrificial layer with the imperfections substantially concentrated in the laser-milled sacrificial layer. The laser-milled sacrificial layer is removed from the workpiece, thereby substantially eliminating imperfections in the laser-milled workpiece.

A number of advantages are provided with the invention. Elimination of notches or aberrations, which are normally formed in the high volume laser drilling manufacturing process, is one benefit. The method also provides flexibility in the choice and thicknesses of sacrificial layers. Since it uses low cost processing and low cost materials, the invention is cost effective. When copper is the sacrificial layer, the copper also functions in capturing debris (as described, for instance, in background patent U.S. Pat. No. 5,609,746). Since aberrations and notches are effectively eliminated, higher power lasers are deployed to further speed the drilling process. Finally, removal of the sacrificial layer (especially in the case of copper) is, in one alternative, delayed until the drilled nozzle plate is delivered for final integration with its inkjet cartridge, providing a basis for a cleaner inkjet head.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 presents a schematic of a laser drilling system;

FIG. 2 (FIGS. 2A through 2E) illustrates a method of using a sacrificial layer to make holes using a laser drilling system;

FIG. 3 provides a perspective view showing major constituent components of an ink-jet printer; and

FIG. 4 provides a schematic cross-sectional view of an ink-jet head.

### DETAILED DESCRIPTION OF THE PREFERRED EMBODIMENTS

The following description of the preferred embodiment(s) is merely exemplary in nature and is in no way intended to limit the invention, its application, or uses.

In overview, one embodiment of the present invention provides a method of eliminating aberrations and notches in an inkjet workpiece by (1) providing a workpiece of stainless steel, (2) depostiting a polymer layer on the workpiece, (3) defining a metal layer on the polymer layer, (4) defining holes in the workpiece, the polymer layer and the metal layer where aberrations and notches are randomly created in the metal layer and (5) removing the metal layer and hence also removing all the random aberrations and notches. This is very advantages where the workpiece is an inkjet nozzle and where the shaped holes each have exactly the same shape.

The present invention provides a method of manufacturing an inkjet nozzle structure that produces controlled and repeatable nozzle shapes without random aberrations or notches normally caused in high volume manufacturing by the lack of control of the laser ablation drilling process. These aberrations or notches are eliminated by using a sacrificial layer where the aberrations or notches are created (instead of within the final structure). However, the shape of the exit holes is controlled since the random aberrations or notches that are normally created by the laser drilling process in the workpiece are instead created in the sacrificial layer only, and are subsequently removed when the sacrificial layer is removed. This process creates a final article of manufacture structure that prevents the laser drilling defects from impacting the quality of the final exit hole.

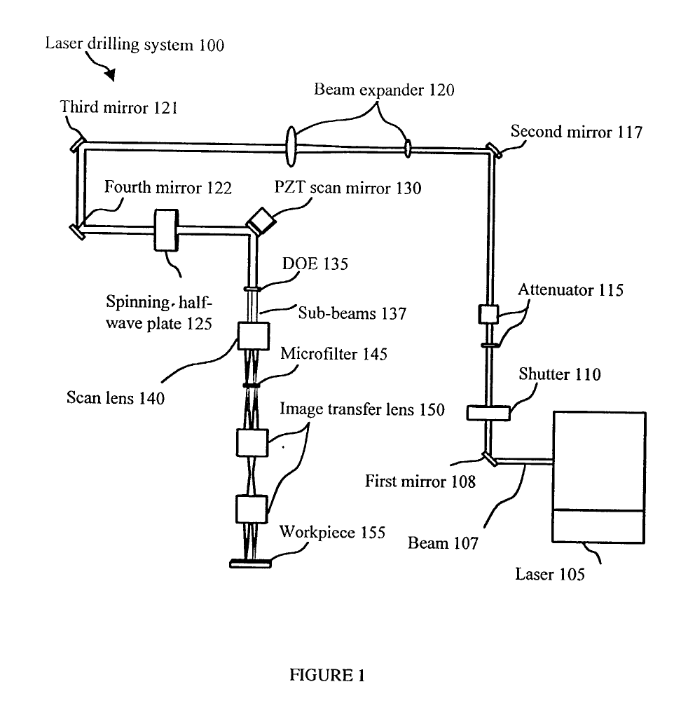

Turning now to specific details in the preferred embodiments, FIG. 1 shows a simplified schematic of a laser drilling system 100, including a laser 105, a beam 107, a shutter 110, an attenuator 115, a beam expander 120, a spinning half-wave plate 125, a first mirror 108, a second mirror 117, a third mirror 121, a fourth mirror 122, a piezo electric transducer (PZT) scan mirror 130, a diffractive optical element (DOE) 135, a plurality of sub-beams 137, a scan lens 140, a microfilter 145, an image transfer lens 150, and a workpiece 155, arranged as shown. All elements of laser drilling system 100 are conventional in laser micromachining.

DOE 135 is a highly efficient beamsplitter and beam array pattern generator so that laser-drilling system 100 drills parallel holes in workpiece 155. The pattern of sub-beams 137 output by DOE 135 is predetermined by the specifications of the holes to be drilled in workpiece 155. In an alternate contemplated embodiment pursuant to anticipated improvements in beam quality of excimer lasers, an excimer laser with a kinoform is used in place of DOE 135. In one example, DOE 135 splits the single incident laser beam from laser 105 into 152 beams in the forms of 4 rows with 38 beams in each row. (See Holmér and Hård's 1995 paper “Laser-machining experiment with an excimer laser and a kinoform” in Applied Optics which is hereby incorporated herein by reference).

Scan lens 140 determines the spot size of sub-beams 137 upon workpiece 155. The beam size that enters scan lens 140 must be less than or equal to the pupil size of scan lens 140. Telecentricity is required to keep the incident angle between sub-beams 137 and workpiece 155 essentially perpendicular, which is necessary to drill parallel holes in workpiece 155. Scan lens 140 is preferably an f-theta telecentric (scan) lens. In alternate embodiments where the axes of the holes do not need to be parallel to each other, a non-telecentric scan lens is used.

Microfilter 145 equalizes the uniformity of sub-beams 137 emitted from laser 105 and through DOE 135. Microfilter 145 consists of dielectric coatings on a glass substrate, and is designed and fabricated according to the intensity patterns of the sub-beams of DOE 135. In one embodiment, microfilter 145 provides two transmission values, 100% and 98%, in a pattern of 152 individual filters of 4 rows with 38 filters in each row (correspondent to DOE 135 as discussed above). In this embodiment, each of the individual filters is circular in shape with a diameter of 250 microns.

Image transfer lens 150 maintains image quality, spot size, and telecentricity, while preventing blowback of ablated particles from workpiece 155 onto microfilter 145 by distancing workpiece 155 an additional focal length away from microfilter 145. In this regard, ablated particles present a hazard to microfilter 145 respective to the proximity between microfilter 145 and workpiece 155. In one embodiment, the image transfer lens consists of two telecentric scan lenses, identical to scan lens 140, placed back-to-back, with the pupil planes of the two scan lenses coinciding in the middle.

Workpiece 155 is the target for picosecond laser drilling system 100. In this example, workpiece 155 is a stainless steel inkjet nozzle foil; however, the present invention is, in alternative embodiments, generalized to a variety of workpiece materials, such as polymers, semiconductor metals, or ceramics. In alternate embodiments, picosecond laser drilling system 100 drills holes of a wide variety of shapes and tapers in workpiece 155.

In operation, laser 105 emits beam 107 along the optical path shown in FIG. 1 above. Beam 107 propagates along the optical path, where it is incident upon first mirror 108. First mirror 108 redirects beam 107 along the optical path to be incident upon shutter 110. Shutter 110 opens and closes to selectively illuminate the workpiece material. Beam 107 exits shutter 110 and propagates along the optical path to attenuator 115. Attenuator 115 filters the energy of laser 105 in order to precisely control ablation parameters. Beam 107 exits attenuator 115 and propagates along the optical path, where it is incident upon second mirror 117. Second mirror 117 redirects beam 107 along the optical path, where it is incident upon beam expander 120.

Beam expander 120 increases the size of beam 107 to match the pupil size of scan lens 140. Beam 107 exits beam expander 120 and propagates along the optical path, where it is incident upon third mirror 121. Third mirror 121 redirects beam 107 along the optical path, where it is incident upon fourth mirror 122. Fourth mirror 122 redirects beam 107 along the optical path, where it is incident upon spinning half-wave plate 125. Spinning half-wave plate 125 changes the polarization of beam 107. Upon exiting spinning half-wave plate 125, beam 107 propagates along the optical path, where it is incident upon PZT scan mirror 130. PZT scan mirror 130 moves in a pre-defined pattern using a drilling algorithm in execution by a real-time control computer (not shown but which should be apparent) to drill the holes in workpiece 155. PZT scan mirror 130 redirects beam 107 along the optical path, where it is incident upon DOE 135. DOE 135 splits beam 107 into a plurality of sub-beams 137, which allow parallel drilling of workpiece 155. Sub-beams 137 exit DOE 135 and propagate along the optical path, where they are incident upon scan lens 140. Scan lens 140 determines the spot size of sub-beams 137 upon workpiece 155. Sub-beams 137 exit scan lens 140 with the correct spot size and propagate along the optical path, where they are incident upon microfilter 145. Microfilter 145 equalizes the uniformity of sub-beams 137. Sub-beams 137 exit microfilter 145 and propagate along the optical path, where they are incident upon image transfer lens 150. Image transfer lens 150 maintains the properties of sub-beams 137 and focuses sub-beams 137 onto workpiece 155. Sub-beams 137 ablate workpiece 155 in a pattern according to the pre-defined drilling algorithm.

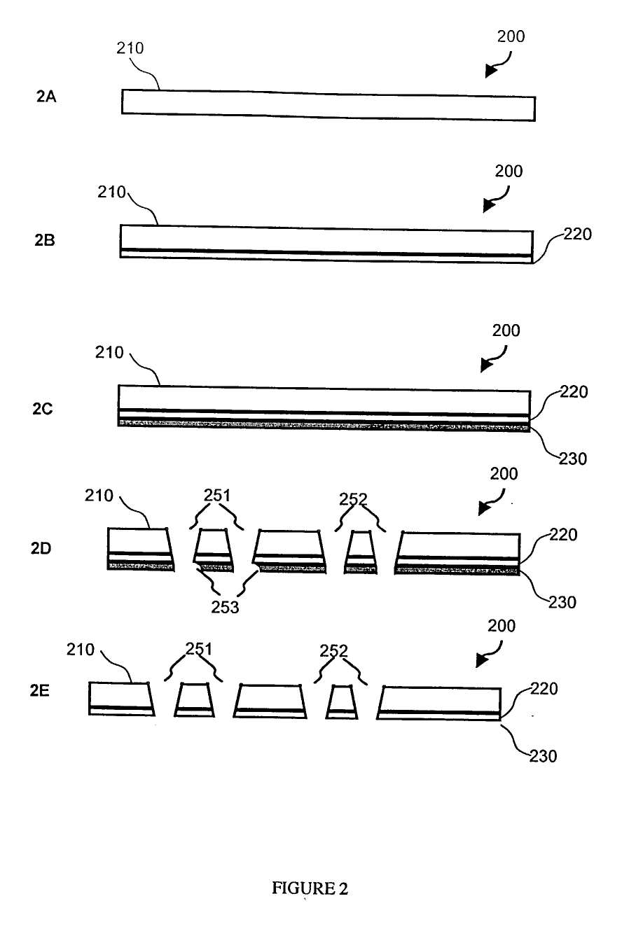

Turning now to a closer consideration of details in the invention, FIG. 2, including FIGS. 2A through 2E, illustrates a method of using a sacrificial layer to make holes using a laser drilling system.

In FIG. 2A, a workpiece 210 (commensurate with the more generalized workpiece 155 of FIG. 1) is provided as the basis of structure 200. Workpiece 210 consists of a stainless steel substrate, which will be used to form an inkjet nozzle. Stainless steels are optimal materials for an inkjet nozzle since they are flexible, durable, and resistive to degradation from the ink environment used in the printer system.

In FIG. 2B, a polymer layer 220 is applied to completely coat one side of workpiece 210. Polymer layer 220 is a hydrophobic material and its purpose is to improve the ink ejection from the inkjet printer. This polymer is typically a 20 to 100 micron thick film of polyimide which is formed by any of a number of deposition processes, including but not limited to (1) spin application and cure, (2) atmospheric deposition of a polymeric film and cure, or (3) roll and press lamination of an adhesive and a polymer film, such as in U.S. Pat. No. 6,120,131.

In FIG. 2C, a metal layer 230, such as copper, is applied to completely coat polymer layer 220, and provide a new beam exit surface of workpiece 210. Metal layer 230 is selected to have similar properties to workpiece 210 such that it ablates similarly using laser drilling system 100. Metal layer 230 is deposited by any of (1) electroless plating of copper on a seed layer of sputtered copper, (2) evaporation, (3) sputtering, or (4) chemical vapor deposition. Typically, copper is deposited to a total thickness of 20-100 microns. Alternative metal materials that can be deposited include aluminum, aluminum alloys, nickel, nickel alloys, and the like. The material is chosen to match as closely as possible the laser ablation properties of workpiece 210 in terms of its ablation rate and thermal dispersion rate as well in consideration of its selective etch properties from stainless steel. In this regard, metal layer 230 must be a substance having (1) a laser ablation rate sufficiently comparable to the workpiece 210 material ablation rate such that aberrations formed from the cutting beam are formed essentially in metal layer 230, (2) a thermal dispersion rate sufficiently comparable to the workpiece 210 material thermal dispersion rate such that aberrations formed from the cutting beam are formed essentially in metal layer 230, and (3) a selective etch property to the etchable material respective to the material of the workpiece 210 and an etching substance selected for use in etching metal layer 230 from the workpiece 210.

In FIG. 2D, holes in-group 251 and in-group 252 are drilled into structure 200 using laser drilling system 100 of FIG. 1. Holes in-group 251 and in-group 252 are drilled according to pre-determined size and geometry specifications, and are drilled by ablating workpiece 210, polymer layer 220 and metal layer 230. As shown, aberrations or notches 253 are created in holes in-group 251, because of the variability of laser ablation parameters. Aberrations or notches 253 are created randomly in holes that are ablated, and always occur near the exit region. In FIG. 2, aberrations or notches 253 are shown in the metal layer 230. Metal layer 230 is of sufficient thickness that any random aberrations or notches 253 are always created in metal layer 230 and not in workpiece 210.

In FIG. 2E, metal layer 230 is removed via a selective wet etch, which removes metal layer 230 but does not affect either polymer layer 220 or workpiece 210. Copper is removed using either a wet etch step, such as a combination of ammonium persulfate/NH₄OH, or a combination of Fe(NO₃)/HCl (see “Metallography, Principles and Practice” by George Vander Voort); or a plasma etch (reactive ion etch such as BCl₃ and Cl). However, this etch does not etch the polymer or stainless steel. As can be seen, by removing metal layer 230, aberrations or notches 253 in metal layer 230 are also removed. Thus, the final inkjet nozzle holes in-group 251 and 252 are produced without these random aberrations or notches 253 and thus provide a controlled shape for inkjet use.

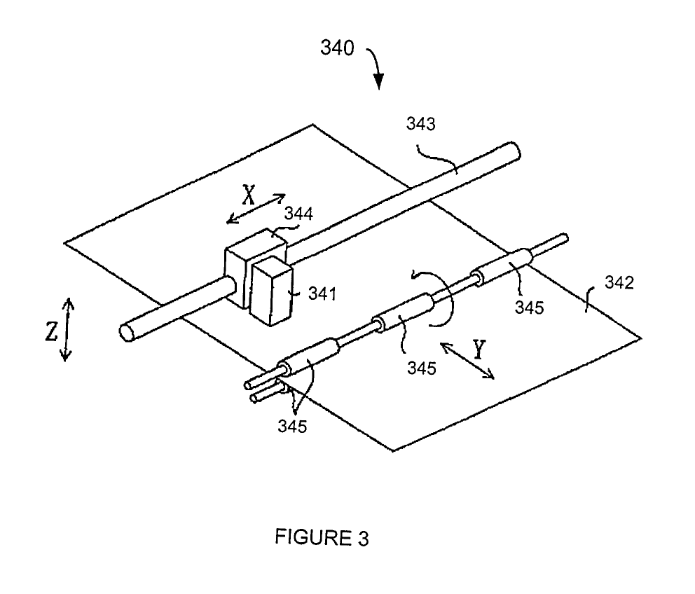

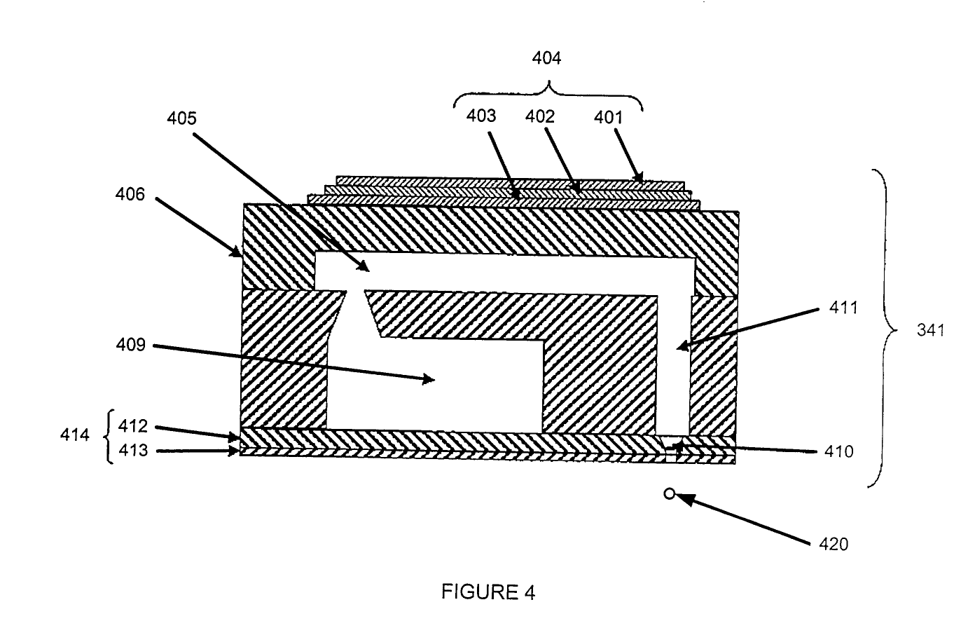

A nozzle plate of an ink-jet head may be constructed with the laser drilling system of the present invention as further detailed in FIGS. 3 and 4.

As shown in FIG. 3, an ink-jet printer 340 has an ink-jet head 341 capable of recording on a recording medium 342 via a pressure generator. Ink droplets emitted from ink-jet head 341 are deposited on the recording medium 342, such as a sheet of copy paper, so that recording is performed on the recording medium 342. The ink-jet head 341 is mounted on a carriage 344 capable of reciprocating movement along a carriage shaft 343. More specifically, the ink-jet head 341 is structured such that it reciprocates in a primary scanning direction X in parallel with the carriage shaft 343. The recording medium 342 is timely conveyed by rollers 345 in a secondary scanning direction Y. The ink-jet head 341 and the recording medium 342 are relatively moved by the rollers 345.

Turning now to FIG. 4, further details in in-jet head 341 are shown. Pressure generator 404 is preferably a piezoelectric system, a thermal system, and/or equivalent system. In this embodiment, the pressure generator 404 corresponds to a piezoelectric system which comprises an upper electrode 401, a piezoelectric element 402, and an under electrode 403. A nozzle plate 414 (an instance of workpiece 155) comprises a nozzle substrate 412 and a water repellent layer 413. The nozzle substrate 412 is made of metal, resin and/or equivalent material. The water repellant layer is made of fluororesin or silicone resin. In this embodiment, the nozzle substrate 412 is made of stainless steel and has a thickness of 50 um, and the water repellent layer is made of a fluororesin and has a thickness of 0.1 um. The ink-jet ink is filled in an ink supplying passage 409, a pressure chamber 405, an ink passage 411, a nozzle 410. Ink droplets 420 are ejected from nozzle 410 as pressure generator 404 pushes on pressure chamber element 406.

As a result of the present invention, very good nozzles are formed without flash and foreign matter (carbon etc) in the nozzle plate. Further, the accuracy of the nozzle outlet diameter is 20 um±1.5 um (a preferred predefined acceptable threshold value for tolerance between the perimeter and the excision edge of the 20 um diameter nozzle outlet).

From the foregoing it will be understood that the present invention provides a provides a system and method for cutting a workpiece with a laser cutting tool with a high degree of precision in the quality of the conformance of the dimensions of the removed portion to the dimensions of the design used in the cutting operation with special value in using a laser to mill exit holes in inkjet nozzles. While the invention has been described in its presently preferred form, it will be understood that the invention is capable of certain modification without departing from the spirit of the invention as set forth in the appended claims.

What is claimed is:

1. A method of substantially eliminating imperfections in a laser milled workpiece, wherein the imperfections result from a laser drilling process, comprising:
attaching a pre-milled sacrificial layer to a beam exit surface of a pre-milled workpiece, wherein the pre-milled sacrificial layer has a first laser ablation rate substantially matching a second laser ablation rate of the pre-milled workpiece;
forming a passage through the pre-milled workpiece and the pre-milled sacrificial layer by ablating workpiece and sacrificial layer material with a laser, thereby producing a laser-milled workpiece and laser-milled sacrificial layer with the imperfections substantially concentrated in the laser-milled sacrificial layer; and
removing the laser-milled sacrificial layer from the workpiece, thereby substantially eliminating imperfections in the laser-milled workpiece.

2. The method of claim 1, wherein said attaching a pre-milled sacrificial layer to a beam exit surface of a pre-milled workpiece corresponds to attaching a pre-milled sacrificial layer substantially composed of copper to a beam exit surface of a pre-milled workpiece substantially composed of stainless steel.

3. The method of claim 1, wherein said attaching a pre-milled sacrificial layer to a beam exit surface of a pre-milled workpiece corresponds to attaching a pre-milled sacrificial layer substantially composed of copper to a beam exit surface of a pre-milled workpiece substantially composed of aluminum.

4. The method of claim 1, wherein said attaching a pre-milled sacrificial layer to a beam exit surface of a pre-milled workpiece corresponds to attaching a pre-milled sacrificial layer substantially composed of copper to a beam exit surface of a pre-milled workpiece substantially composed of nickel.

5. The method of claim 1, wherein said attaching a pre-milled sacrificial layer to a beam exit surface of a pre-milled workpiece comprises:
defining a polymer layer on a surface of the pre-milled workpiece; and
defining a metal layer on a surface of the polymer layer, wherein the metal layer corresponds to the pre-milled sacrificial layer.

6. The method of claim 5, wherein said defining a metal layer corresponds to defining a metal layer composed substantially of copper metal.

7. The method of claim 5, wherein said defining a polymer layer corresponds to defining a hydrophobic polyimide layer.

8. A laser-milled workpiece created according to the method of claim 1.

9. The laser-milled workpiece of claim 8, wherein the workpiece corresponds to an inkjet nozzle plate having an inkjet nozzle milled therein.

10. An inkjet head having the inkjet nozzle of claim 9.

11. An inkjet printer having the inkjet head of claim 10.

12. The method of claim 1, wherein the sacrificial layer has a first thickness and the pre-milled workpiece has a second thickness not equal to the first thickness, wherein the first thickness is selected based on the first ablation rate to ensure that the imperfections result from the laser drilling process are substantially concentrated in the sacrificial layer.

13. A laser-milling structure comprising:
a workpiece layer having a beam entrance surface and a beam exit surface; and
a sacrificial layer attached to the beam exit surface of said workpiece layer,
wherein said sacrificial layer has a first laser ablation rate substantially matching a second laser ablation rate of said workpiece layer, thereby ensuring that imperfections resulting from formation of a passage through said workpiece layer by a laser-milling process ablating from the beam entrance surface to the beam exit surface are substantially concentrated in said sacrificial layer.

14. The structure of claim 13, wherein said workpiece layer corresponds to a metallic layer resistant to dissolution via an electrolytic process, and said sacrificial layer corresponds to metallic layer subject to dissolution via an electrolytic process, the structure further comprising a polymer layer disposed between said workpiece layer and said sacrificial layer.

15. The structure of claim 13, comprising a passage formed through said workpiece layer by a laser-milling process ablating from the beam entrance surface to the beam exit surface.

16. A method of preparing a workpiece layer for laser-milling, comprising:
designating a first surface of the workpiece layer as a beam entrance surface;
designating a second surface of the workpiece layer as a beam exit surface;
anticipating formation of a passage through said workpiece layer by a laser-milling process ablating from the beam entrance surface to the beam exit surface; and
attaching a sacrificial layer to the beam exit surface of said workpiece layer, wherein said sacrificial layer has a first laser ablation rate substantially matching a second laser ablation rate of said workpiece layer, thereby ensuring that imperfections resulting from formation of the passage through the workpiece layer by the laser-milling process ablating from the beam entrance surface to the beam exit surface are substantially concentrated in the sacrificial layer.

17. The method of claim 16, wherein said workpiece layer corresponds to a first metallic layer resistant to dissolution via an electrolytic process, and said sacrificial layer corresponds to a second metallic layer subject to dissolution via an electrolytic process, the method further comprising disposing a polymer layer between said workpiece layer and said sacrificial layer.

18. The method of claim 16, wherein the sacrificial layer has a first thickness and the pre-milled workpiece has a second thickness not equal to the first thickness, wherein the first thickness is selected based on the first ablation rate to ensure that the imperfections result from the laser drilling process are substantially concentrated in the sacrificial layer.

19. A method of laser-milling a workpiece, comprising:
obtaining a workpiece structure prepared for laser milling, the structure comprising:
(a) a workpiece layer having a beam entrance surface and a beam exit surface; and
(b) a sacrificial layer attached to the beam exit surface of said workpiece layer, wherein said sacrificial layer has a first laser ablation rate substantially matching a second laser ablation rate of said workpiece layer, thereby ensuring that imperfections resulting from formation of a passage through said workpiece layer by a laser-milling process ablating from the beam entrance surface to the beam exit surface are substantially concentrated in said sacrificial layer; and
forming a passage through said workpiece layer by a laser-milling process ablating from the beam entrance surface to the beam exit surface.

20. The method of claim 19, wherein the sacrificial layer has a first thickness and the pre-milled workpiece has a second thickness not equal to the first thickness, wherein the first thickness is selected based on the first ablation rate to ensure that the imperfections result from the laser drilling process are substantially concentrated in the sacrificial layer.

21. A method of finishing a laser-milled workpiece comprising:
obtaining a laser-milled workpiece structure, the structure comprising:
(a) a workpiece layer having a beam entrance surface and a beam exit surface;
(b) a sacrificial layer attached to the beam exit surface of said workpiece layer, wherein said sacrificial layer has a first laser ablation rate substantially matching a second laser ablation rate of said workpiece layer, thereby ensuring that imperfections resulting from formation of a passage through said workpiece layer by a laser-milling process ablating from the beam entrance surface to the beam exit surface are substantially concentrated in said sacrificial layer; and
(c) a passage formed through said workpiece layer by a laser-milling process ablating from the beam entrance surface to the beam exit surface; and
removing the sacrificial layer, thereby finishing the workpiece.

22. The method of claim 21, wherein the workpiece layer corresponds to a first metallic layer resistant to dissolution via an electrolytic process, the sacrificial layer corresponds to a second metallic layer subject to dissolution via an electrolytic process, and said removing the sacrificial layer corresponds to dissolving said sacrificial layer via an electrolytic process.

23. The method of claim 21, wherein said obtaining the laser-milled workpiece corresponds to obtaining a laser-milled workpiece having a hydrophobic polyimide layer disposed between the workpiece layer and the sacrificial layer.

24. The method of claim 21, wherein the sacrificial layer has a first thickness and the pre-milled workpiece has a second thickness not equal to the first thickness, wherein the first thickness is selected based on the first ablation rate to ensure that the imperfections result from the laser drilling process are substantially concentrated in the sacrificial layer.

25. A method of cutting a workpiece with a laser cutting tool, said cutting proceeding according to a pre-determined pattern, said laser cutting tool providing a cutting beam, said workpiece having a beam exit surface where said cutting beam exits said workpiece after cutting said workpiece, said method comprising the steps of:
determining a material ablation rate of said workpiece when cut by said cutting beam;
determining a thermal dispersion rate of said workpiece when cut by said cutting beam;
securing an etchable material layer to the beam exit surface of said workpiece, said etchable material layer comprising a substance having a laser ablation rate sufficiently comparable to said workpiece material ablation rate such that aberrations formed from said cutting beam are formed essentially in said etchable material layer, a thermal dispersion rate sufficiently comparable to said workpiece material thermal dispersion rate such that aberrations formed from said cutting beam are formed essentially in said etchable material layer, and a selective etch property to said etchable material respective to the material of said workpiece and an etching substance selected for use in etching said etchable material layer from said workpiece;
activating said laser tool to cut said workpiece according to said pattern; and
etching said etchable material layer from said workpiece with said etching substance.

26. The method of claim 25, wherein said workpiece material comprises a stainless steel and said etchable material is copper.

27. The method of claim 26 wherein said copper material layer has a thickness of between about 20 and about 100 microns.

28. The method of claim 25 wherein said workpiece material comprises selected from aluminum or nickel.

29. The method of claim 28 wherein said aluminum workpiece material comprises an aluminum alloy.

30. The method of claim 28 wherein said nickel workpiece material comprises a nickel alloy.

31. The method of claim 25, wherein said etching substance is either ammonium persulfate or a blend of ferric nitrate and hydrochloric acid.

32. The method of claim 26, wherein said etching substance is either ammonium persulfate or a blend of ferric nitrate and hydrochloric acid.

33. A method of cutting a portion from a workpiece with a laser cutting tool, said portion having a pre-determined perimeter defining the outer boundary of said portion, said laser cutting tool providing a cutting beam, said workpiece having a beam exit surface where said cutting beam exits said workpiece after cutting said workpiece, said method comprising the steps of:
securing a hydrophobic polymer layer to the beam exit surface of said workpiece;
determining a material ablation rate of said workpiece when cut by said cutting beam;
determining a thermal dispersion rate of said workpiece when cut by said cutting beam;
securing an etchable material layer to said polymer layer, said etchable material layer comprising a substance having a laser ablation rate sufficiently comparable to said workpiece material ablation rate such that aberrations formed from said cutting beam are formed essentially in said etchable material layer, a thermal dispersion rate sufficiently comparable to said workpiece material thermal dispersion rate such that aberrations formed from said cutting beam are formed essentially in said etchable material layer, and a selective etch property respective to the material of said workpiece and an etching substance selected for use in etching said etchable material layer from said workpiece;
activating said laser tool to cut said workpiece along said perimeter so that said portion is cut from said workpiece; and
etching said etchable material layer from said workpiece with said etching substance.

34. The method of claim 33 wherein said hydrophobic polymer layer is a polyimide.

35. The method of claim 34 wherein said polyimide layer has a thickness of between about 20 and about 100 microns.

36. The method of claim 34 wherein said workpiece material comprises a stainless steel and said etchable material is copper.

37. The method of claim 36 wherein said copper material layer has a thickness of between about 20 and about 100 microns.

38. The method of claim 33 wherein said workpiece material comprises a material selected from aluminum or nickel.

39. The method of claim 38 wherein said aluminum workpiece material comprises an aluminum alloy.

40. The method of claim 38 wherein said nickel workpiece material comprises a nickel alloy.

41. The method of either of claim 36 wherein said etching substance is either ammonium persulfate or a blend of ferric nitrate and hydrochloric acid.

42. The method of claim 37 wherein said etching substance is either ammonium persulfate or a blend of ferric nitrate and hydrochloric acid.

43. A method of cutting a discharge aperture in the nozzle plate body of an inkjet nozzle with a laser cutting tool, said aperture having a pre-determined perimeter defining the location of the edge of said aperture in said nozzle plate body, said laser cutting tool providing a cutting beam, said body having a beam exit surface where said cutting beam exits said body after cutting said body, said method comprising the steps of:
securing a hydrophobic polymer layer to the beam exit surface of said body;
determining a material ablation rate of said body when cut by said cutting beam;
determining a thermal dispersion rate of said body when cut by said cutting beam;
securing an etchable material layer to said polymer layer, said etchable material layer comprising a substance having a laser ablation rate sufficiently comparable to said body material ablation rate such that aberrations formed from said cutting beam are formed essentially in said etchable material layer, a thermal dispersion rate sufficiently comparable to said body material thermal dispersion rate such that aberrations formed from said cutting beam are formed essentially in said etchable material layer, and a selective etch property respective to the material of said body and an etching substance selected for use in etching said etchable material layer from said body;
activating said laser tool to cut said body along said perimeter so that said aperture is cut into said body; and
etching said etchable material layer from said body with said etching substance.

44. The method of claim 43 wherein said hydrophobic polymer layer is a polyimide.

45. The method of claim 44 wherein said polyimide layer has a thickness of between about 20 and about 100 microns.

46. The method of claim 43 wherein said body material comprises a stainless steel and said etchable material is copper.

47. The method of claim 45 wherein said copper material layer has a thickness of between about 20 and about 100 microns.

48. The method of claim 43 wherein said body material is selected from aluminum or nickel.

49. The method of claim 48 wherein said body material comprises an aluminum alloy.

50. The method of claim 48 wherein said body material comprises a nickel alloy.

51. The method of either of claim 46 wherein said etching substance is either ammonium persulfate or a blend of ferric nitrate and hydrochloric acid.

52. The method of either of claim 47 wherein said etching substance is either ammonium persulfate or a blend of ferric nitrate and hydrochloric acid.

53. An inkjet nozzle produced by the process of cutting a discharge aperture in the nozzle plate body of an inkjet nozzle with a laser cutting tool, said aperture having a pre-determined perimeter defining the location of the edge of said aperture in said nozzle plate body, said laser cutting tool providing a cutting beam, said body having a beam exit surface where said cutting beam exits said body after cutting said body, said method comprising the steps of:
securing a hydrophobic polymer layer to the beam exit surface of said body;
determining a material ablation rate of said body when cut by said cutting beam;
determining a thermal dispersion rate of said body when cut by said cutting beam;
securing an etchable material layer to said polymer layer, said etchable material layer comprising a substance having a laser ablation rate sufficiently comparable to said body material ablation rate such that aberrations formed from said cutting beam are formed essentially in said etchable material layer, a thermal dispersion rate sufficiently comparable to said body material thermal dispersion rate such that aberrations formed from said cutting beam are formed essentially in said etchable material layer, and a selective etch property respective to the material of said body and an etching substance selected for use in etching said etchable material layer from said body;
activating said laser tool to cut said body along said perimeter so that said aperture is cut into said body; and
etching said etchable material layer from said body with said etching substance.

54. The method of claim 53 wherein said hydrophobic polymer layer is a polyimide.

55. The method of claim 54 wherein said polyimide layer has a thickness of between about 20 and about 100 microns.

56. The method of claim 53 wherein said body material comprises a stainless steel and said etchable material is copper.

57. The method of claim 56 wherein said copper material layer has a thickness of between about 20 and about 100 microns.

58. The method of claim 53 wherein said body material is selected from aluminum or nickel.

59. The method of claim 58 wherein said body material comprises an aluminum alloy.

60. The method of claim 58 wherein said body material comprises a nickel alloy.

61. A laser-milled workpiece, comprising:
a layer of material, wherein the layer has a beam entrance surface and a beam exit surface;
a laser-milled passage formed in said layer of material via laser ablation from the beam entrance surface to the beam exit surface, wherein the laser-milled passage has an exit hole in the beam exit surface, and an entrance hole in the beam entrance surface, and the entrance hole is not smaller than the exit hole,
wherein inner walls of said laser-milled passage between the beam entrance surface and the beam exit surface describe perimeters of planar spatial regions parallel to a planar surface region of the beam exit surface surrounding the exit hole, wherein the planar spatial regions progressively decrease in area in a direction described as from the entrance hole toward the exit hole, and
wherein the beam exit surface is smooth in the planar surface region surrounding the exit hole, with no material of said layer of material extending beyond the planar surface region in the first direction.

62. The workpiece of claim 61, wherein said workpiece is an inkjet nozzle.
